(19) United States
(12) Patent Application Publication
(10) Pub. No.: US 2024/0283362 A1
(43) Pub. Date: Aug. 22, 2024

(54) INDUCTION HOB

(71) Applicant: WHIRLPOOL CORPORATION, BENTON HARBOR, MI (US)

(72) Inventors: SALVATORE BALDO, VARESE (IT); MARIO BARBATI, VARESE (IT); ANDREA GALLIVANONI, VARESE (IT); SILVIO SPERONE, VARESE (IT)

(73) Assignee: WHIRLPOOL CORPORATION, BENTON HARBOR, MI (US)

(21) Appl. No.: 18/414,911

(22) Filed: Jan. 17, 2024

(30) Foreign Application Priority Data
Feb. 17, 2023 (EP) 23157385.8

(51) Int. Cl. H02M 3/335; H02M 3/00; H05B 6/08; H05B 6/12

(52) U.S. Cl. CPC H02M 3/335; H02M 3/01; H05B 6/08; H05B 6/1209

(57) ABSTRACT

An induction hob includes at least one heating induction coil and a switching converter. The switching converter includes a DC-bus having a high-side line, a low-side line and a plurality of half-bridge switching stages. A C-L-C resonant tank defined by the heat induction coil electrically connected in series between the two capacitors is installed on the circuit board and is connected between two intermediate current terminals of two half-bridge switching stages. Each capacitor is connected in series to the induction heating coil and to the intermediate current terminal of a respective half-bridge switching stage, wherein the C-L-C resonant tank may be magnetically coupled with a respective load. The intermediate current terminal of each half-bridge switching stage is directly connected to a capacitor. Each half-bridge switching stage and the respective capacitor directly connected thereto are installed on the same circuit board.

### CROSS-REFERENCE TO FOREIGN PRIORITY APPLICATION

The present application claims the benefit under 35 U.S.C. §§ 119(b), 119(e), 120, and/or 365(c) of a European Application No. EP23157385.8 filed Feb. 17, 2023.

### FIELD OF THE INVENTION

The present disclosure relates to an induction hob having one or more induction heating coils, wherein each induction heating coil is connected between two capacitors to form a C-L-C resonant tank.

### BACKGROUND OF THE INVENTION

Cooking appliances, in particular induction cooking appliances, have at least one main switching converter to supply induction heating elements with a regulated supply power generated from a main energy supply, and an energy storage unit, in particular a bus capacitor, provided for smoothing bus voltage variations by charging/discharging a capacitor. Switching converters may be used as AC current generators (inverters) for induction cooktops, for powering heating coils magnetically coupled with pots/pans.

In induction cooktops typically the load is a series resonant circuit composed of a capacitor and an inductor, wherein the inductor represents the induction coil and the pot placed on the cooktop surface above it. A typical driving of a full bridge inverter is illustrated in FIGS. 1a-1c. The topology consists of two legs connected between the DCBUS and ground nodes, each of which comprises two switching devices. A resonant load is connected between the two intermediate terminals of each half-bridge stage, as shown in FIG. 1 a). In normal operation, the switching devices in a full bridge topology are switched ON and OFF in a definite pattern. Referring to FIGS. 1 a), S1 and S2 will never be activated at the same time, and similarly S3 and S4 will never be activated at the same time, otherwise a short-circuit of the DCBUS would be created. On the other hand, switching devices that are located diagonally in different legs are activated at the same time to have current flowing through the load, in this case the resonant series of an inductor and a capacitor. Referring to FIGS. 1 b), S1 and S4 will be turned on at the same time to have current flow through the load; after a predetermined amount of time, S1 and S4 are turned off, and S2 and S3 are turned on, as shown in FIG. 1 c). This way, the current through the load will flow in the opposite direction as before, thus creating an alternating current through the load at a frequency corresponding to the switching frequency of the devices. In this case, the load is a series resonant circuit composed of a capacitor and an inductor plus a resistor, which represents the induction coil and the pot placed on the cooktop surface above it.

A half bridge topology is depicted in FIG. 2a and a full bridge topology is depicted in FIG. 2b, with respective exemplary time graphs at the bottom. The sample time graphs have been obtained by simulation at 230 VAC (peak of DCBUS of 325 V), with a load model formed by an inductance of 62 μH and a resistance of 5Ω for the half bridge case and 20Ω for full bridge case, with a capacitor of 220 nF for each case. The value of the equivalent resistance changes to have the same power in both cases. The depicted signals represent the current circulating in the resonant load and the voltage across the resonant load (V_AB) and across the capacitor Cres1 (V_CB). The working frequency is fixed around 44 kHz, which is about the resonance frequency of the equivalent RLC resonant load.

Compared to the half bridge, one of the main advantages of the full bridge inverter is that the voltage across the load is doubled, because it alternately passes from DCBUS to DCBUS. A doubled voltage, with the same power, results in half the current, obtaining an improvement in efficiency compared to the half bridge. In the case of the half bridge, the current reaches about 40 A peak while in the case of the full bridge it reaches about 20 A. This happens because the voltage across the resonant load (V_AB) is double in the case of the full bridge. This leads to an increase in the efficiency of the system, since the dissipations depend on the circulating currents. However, the high voltage leads to the choice of a capacitor capable of working at that voltage, making the component more expensive and with lower efficiency.

Tests carried out by the Applicant on an induction hob comprising the configuration of FIG. 2b for driving an induction coil of the induction hob, have shown a relevant amount of electromagnetic disturbance injected through the ground line of the induction hob. A diagram of the disturbance voltage injected through the ground line of the full-bridge stage is depicted by way of example in FIG. 3. Measures are taken at a fixed switching frequency. The vertical axis represents the amplitude in dB of the disturbance voltage injected into the main line. The horizontal axis indicates the frequencies at which disturbances are observed. This disturbance voltage has a peak at the main switching frequency, which in the depicted graph is at about 44 kHz, and at its upper harmonics (88 kHz, 132 kHz, 176 kHz, 220 kHz, 264 kHz). Unfortunately, the amplitude at the main switching frequency is about 20 dB higher than the amplitude at frequencies around it, thus it would be desirable to reduce this undesired effect.

The Japanese patent publication JP2008-159358, upon the disclosure of which the preamble of claim 1 is drafted, discloses an induction hob with a switching stage as depicted in FIG. 4 in which two distinct induction heating coils are controlled by driving the master half-bridge stage 4c and the two slave half-bridge stages 4a and 4b. Also with this prior switching stage the disturbance injected through the ground line of the induction hob are relevant.

### SUMMARY OF THE INVENTION

Tests carried out by the Applicant lead to conclude that the cause of the disturbance that are injected through the ground line of induction hobs using a full-bridge switching converter, may be caused by parasitic capacitances between the ground line and the connection lines to the heating coil of the induction hob. In order to solve at least partially this inconvenience, an induction hob as claimed has been devised in which all half-bridge switching stages and the respective capacitors directly connected thereto are all installed on a same circuit board. Thanks to this configuration, a C-L-C topology is obtained allowing to reduce EMI disturbances.

Other embodiments are defined in the enclosed claims.

### BRIEF DESCRIPTION OF THE DRAWINGS

FIGS. 1a-1c illustrate a typical driving of a resonant R-L-C load by means of a full bridge switching stage;

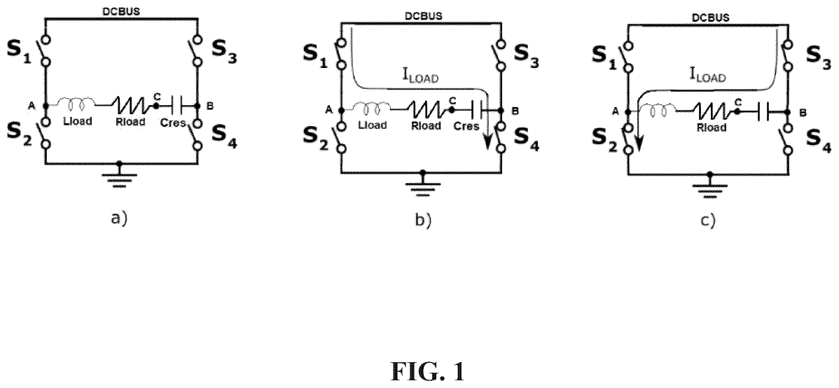

FIG. 2a depicts a half-bridge topology configured to supply a R-L-C resonant load and exemplary time graphs of voltages and current;

FIG. 2b depicts a full-bridge topology configured to supply a R-L-C resonant load and exemplary time graphs of voltages and current;

FIG. 3 depicts a diagram of a disturbance voltage injected through the ground line observed between 0 and 10 MHz of the full-bridge stage of FIG. 2b;

FIG. 4 depicts a prior art switching stage;

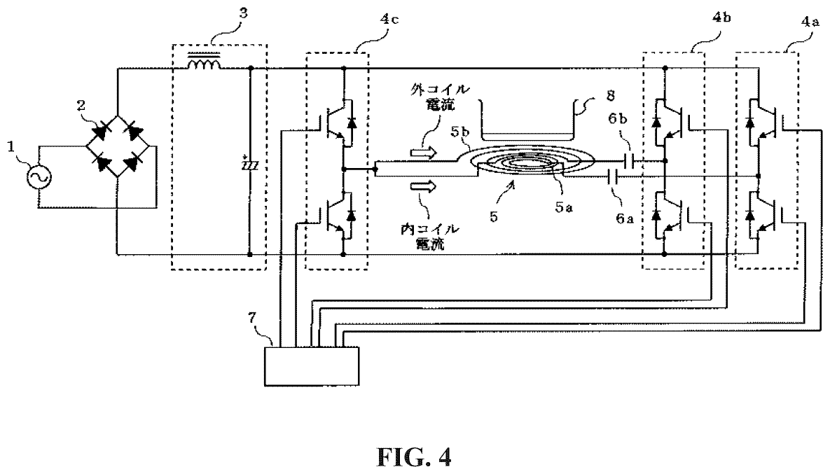

FIG. 5 depicts the full-bridge topology of FIG. 2b and examples of waveforms of voltages across the coil with respect to ground that inject disturbances through the ground line;

FIG. 6a depicts a full-bridge topology for an induction hob according to an aspect of this disclosure with two capacitors and exemplary time graphs of voltages and current, wherein each capacitor is directly connected to the intermediate terminal of a respective half-bridge stage.

FIG. 6b depicts the full-bridge topology of FIG. 6a and examples of waveforms of voltages across the coil with respect to ground that inject disturbances through the ground line;

FIG. 7 depicts a diagram of a disturbance voltage injected through the ground line observed between 0 and 10 MHz of the full-bridge stage of FIG. 6b;

FIG. 8 depicts multiple full-bridge stages for an induction hob according to an aspect of this disclosure;

FIG. 9 depicts multiple full-bridge stages for an induction hob according to an aspect of this disclosure, comprising a single master half-bridge stage and a plurality of slave half-bridge stages for powering a plurality of induction heating coils; and

FIG. 10 depicts multiple full-bridge stages for an induction hob according to an aspect of this disclosure, comprising a first plurality of “m” master half-bridge stage and a second plurality of “n” slave half-bridge stages for powering a plurality of “n*m” induction heating coils.

### DETAILED DESCRIPTION OF THE EMBODIMENTS

Without being bound to a theory, the Applicant believes that a cause of the relevant amount of disturbance current injected through the ground line may be due to the parasitic capacitances between the ground line and the connection lines to the heating coil of an induction hob. Unfortunately, parasitic capacitances between the terminals of an induction heating coil and the ground line are unavoidable. For instance, in the case of a metallic outer case connected to the ground line, the parasitic capacitances between the induction coil terminals and the ground line of the power supply cable generate leakage currents resulting in disturbances of the power line.

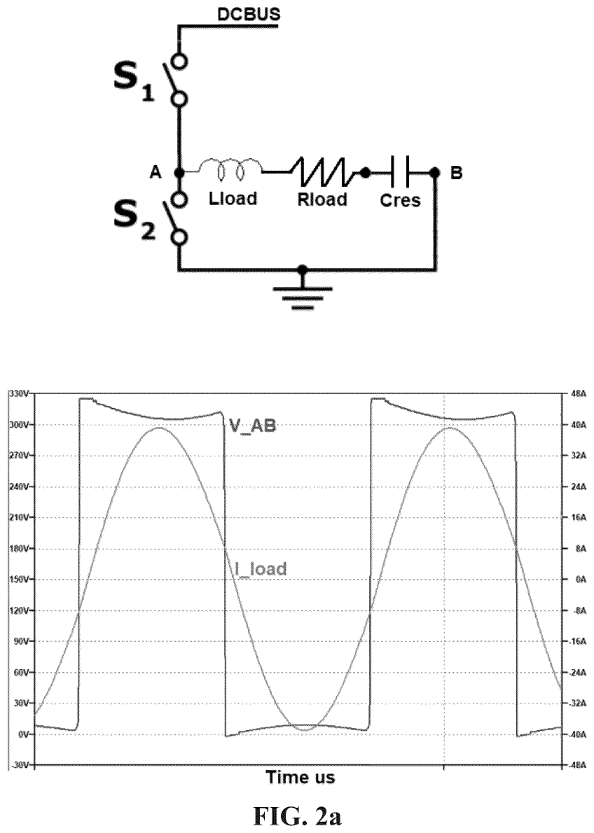

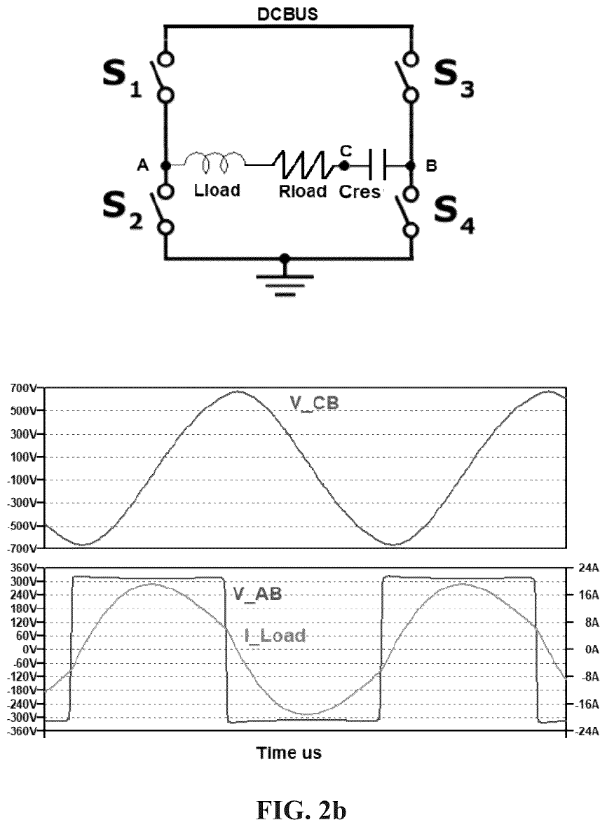

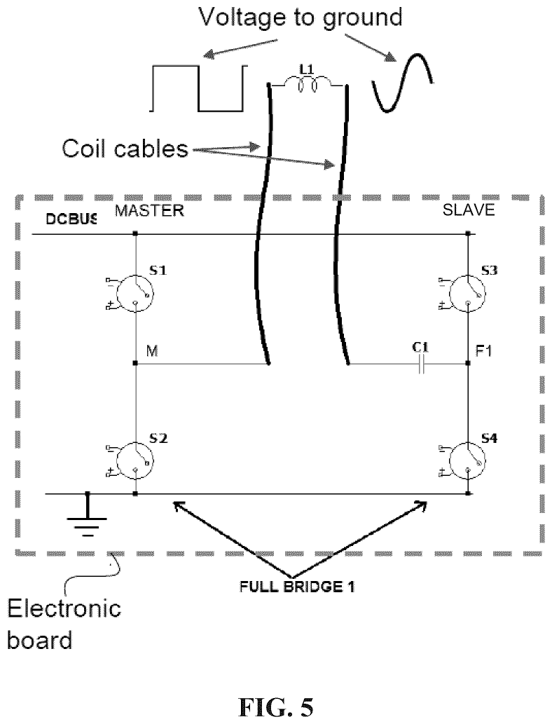

However, it is possible to reduce the disturbance current injected through the ground line. FIG. 5 depicts the full-bridge topology of FIG. 2b and an example of the waveforms of voltages across the coil with respect to ground that inject disturbances through the ground line. Clearly, by using the well known L-C resonant configuration, the waveforms of the voltages to ground at the terminals of the induction heating coil are very different from each other: the voltage to ground is a square wave at the terminal of the coil directly connected to the half-bridge stage, whilst it has a lesser harmonic content at the other terminal of the coil connected to the other half-bridge switching stage through the capacitor. Therefore, the harmonic content of the square-wave voltage to ground at one terminal is not balanced by the harmonic content of the voltage to ground at the other terminal and this will cause circulation through the ground line of a relevant disturbance current.

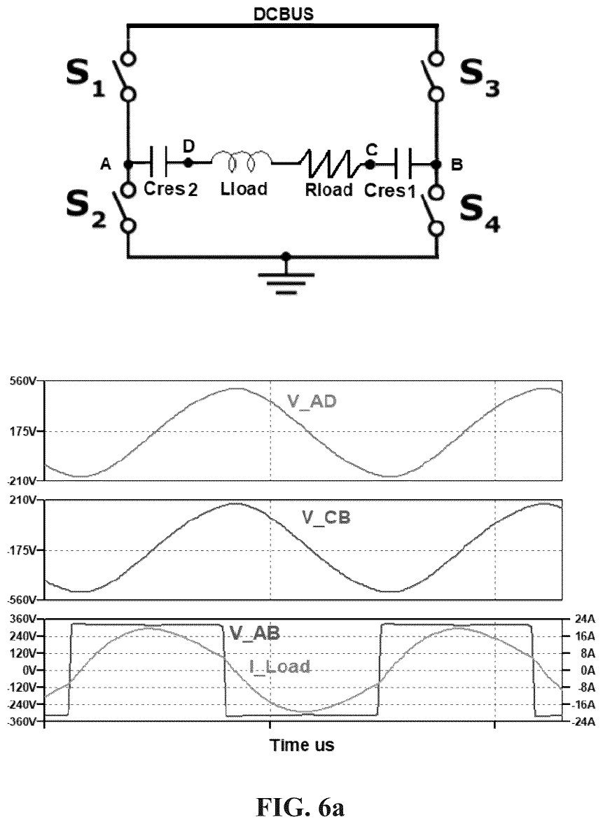

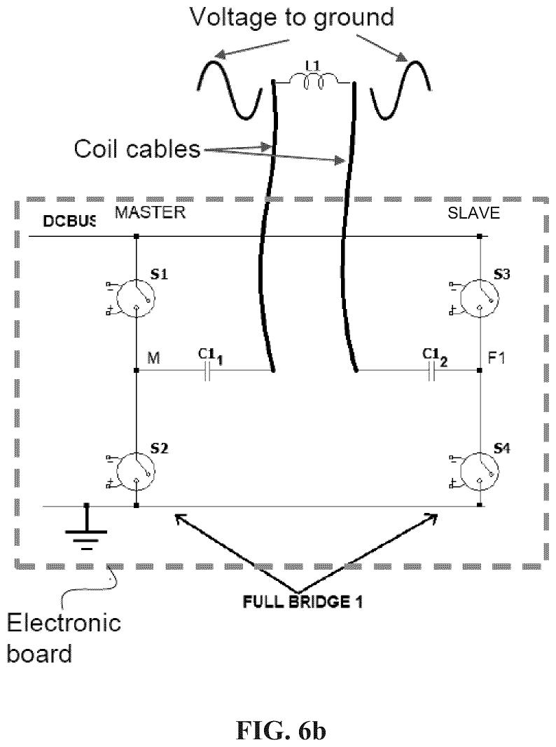

According to an aspect of the present disclosure, it is possible to power the induction heating coil using the circuit in FIGS. 6a and 6b, which has a full bridge topology with two capacitors wherein each capacitor is directly connected to the intermediate terminal of a respective half-bridge stage to form a C-L-C resonant element. Thanks to the presence of two capacitors that couple respective terminals of the induction heating coil to the intermediate terminal of the respective half-bridge switching stage, the voltages to ground at the terminals of the induction heating coil have a lesser harmonic content than a square-wave voltage and thus they will cause circulation of a reduced disturbance current through the ground line. In a configuration where each one of the two capacitors is installed on a same electronic board with the respective half-bridge switching stage and the electronic board(s) is(are) electrically shielded from the ground line and from the parts of the induction hob eventually connected thereto, the square-wave voltages at the intermediate nodes of the switching stages will have a limited effect on the generation of a disturbance current through the ground line.

According to an aspect of the disclosure, the capacitors C of the same resonant load preferably have matched values so that the voltages on the capacitors are balanced, as schematically shown at the bottom of FIG. 6a. The simulation data are the same as in FIG. 2b and the signals represent the voltage across the intermediate terminals of the half-bridge stages, the total current flowing through the load, the voltage across the capacitor Cres 1 (V_CB) and the voltage across the second capacitor Cres 2 (V_AD). As a further advantage, the voltage across the capacitors is reduced, for example it is reduced from a peak of about 700V to about 500V, thus voltage isolation requirements may be more easily satisfied.

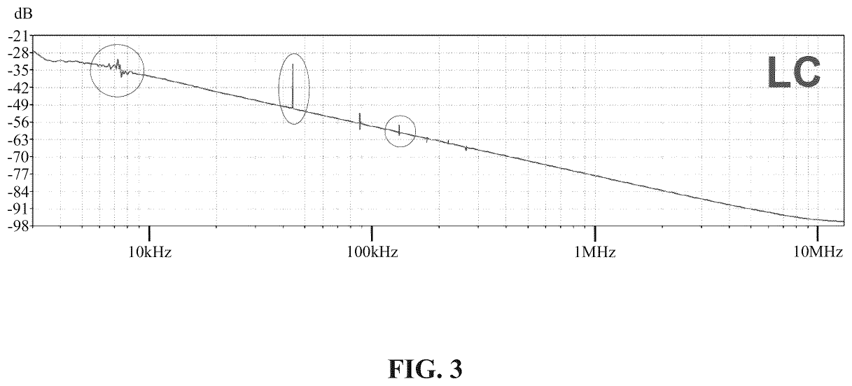

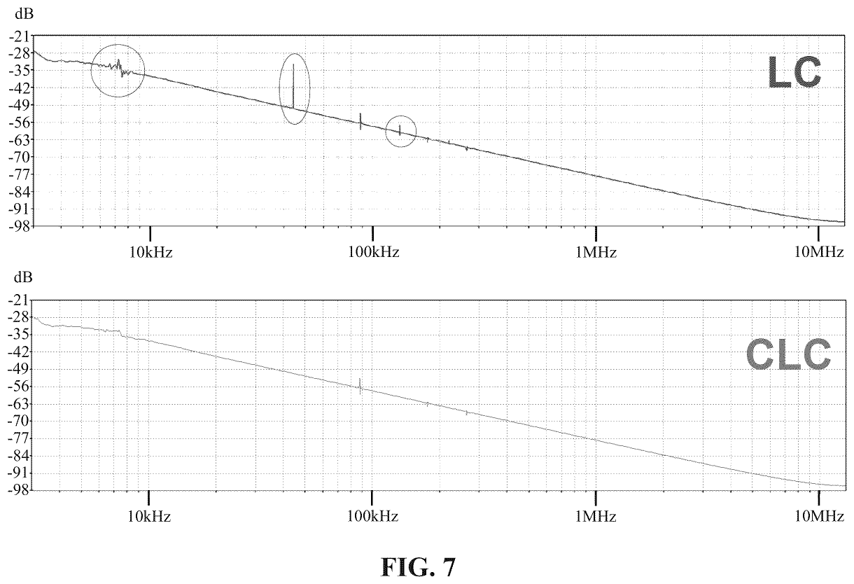

In the embodiment shown in FIG. 6b, the capacitors, which for example may be installed on a same electronic board or may be installed each one on a respective electronic board with the respective half-bridge stage, have matched values and the voltages to ground at the terminals of the induction heating coil are balanced, thus their effect on the generation of the disturbance current are at least partially balanced. A test carried out by the Applicant on the configuration of FIG. 6b using matched capacitors, showed that the annoying disturbance on the ground line highlighted in the graph of FIG. 3 are substantially canceled, as shown in the corresponding graph of FIG. 7.

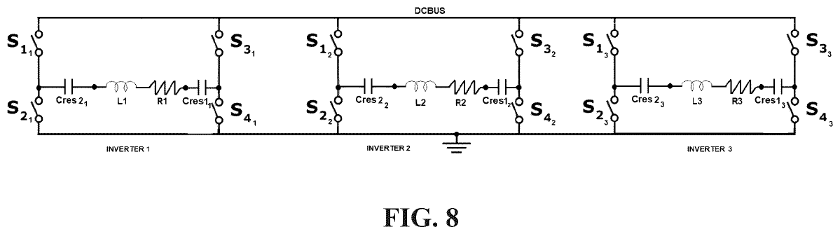

The present invention may be generalized in a multi inverter system, in which it is possible to have more than one full bridge with a corresponding C-L-C resonant tank sharing the same DCBUS, as shown in FIG. 8. Considering a three-phase system, in which it is possible to obtain three different DCBUSs, one for each phase, it is possible to generalize the topology in FIG. 8 in which for each DCBUS it is possible to have many C-L-C full bridges based on the number of coils to be energized. Of course, the maximum number of converters connected to the same DCBUS depends on the maximum power limitations of the individual inverters and the electrical network. Also in this case, the capacitors will be installed on the same electronic board as the half-bridge stages, whilst only the induction heating coil will be installed out of it.

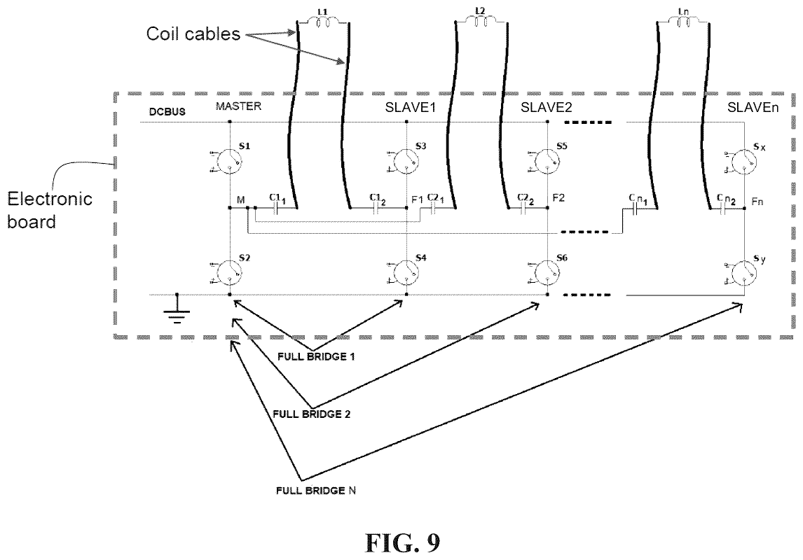

FIG. 9 shows a possible cost saving solution for powering a number “n” of induction heating coils. This topology consists of a half-bridge stage, which is configured to act as a Master stage, and “n” secondary half-bridge stages, as many as there are coils in the system, wherein the secondary half-bridge stages are configured to act as Slave stages. For example, if the second coil (L2) is to be supplied, the Master and the slave half-bridge stage (SLAVE 2) connected to the second coil will be turned on, so as to obtain a full bridge structure for that coil, with a resonant load formed by the first capacitor C21 connected to the master half-bridge stage, the coil L2 and the second capacitor C22 connected to the slave half-bridge stage. If the first and second coils (L1 and L2) are to be supplied, the Master half-bridge stage will be shared between the slave half-bridge stages SLAVE1 and SLAVE2, obtaining a resonant load C11-L1-C12 for coil 1 and C21-L2-C22 for coil 2.

The number of converters and coils depends:
on the final dimensions of the product;
on the maximum power limitations of the individual inverters;
on the power limitations of the electrical network.

Compared to the configuration in FIG. 8, in this case there are considerable cost savings because there are less half-bridge stages.

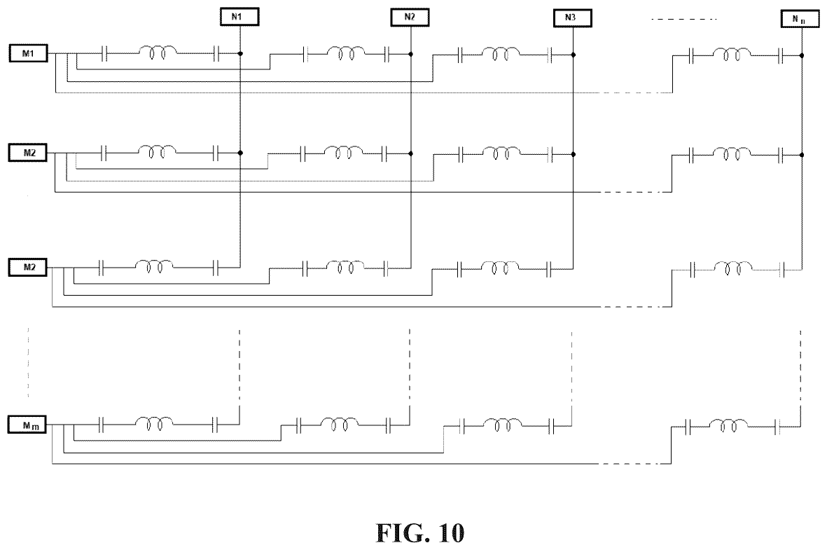

The topology in FIG. 9 may be generalized by obtaining a matrix structure as in FIG. 10, where the single converter blocks (M and N) are half-bridge stages. For example, let us suppose there is a unique DC BUS from the electrical network. In this case, it could be possible to have a matrix system connected to the DC BUS, with M half-bridge stages configured to act as master half-bridge stages, and N half-bridge switching stages each of which is configured to act as a slave half-bridge stage. According to one aspect, each one of the M master half-bridge stages is operably coupled to each one of the N slave half-bridge stages through a C-L-C resonant tank. In this case, a system with M×N coils is obtained in which each coil of the M×N coils is connected between one master half-bridge stage and one slave half-bridge stage.

1-5. (canceled)

6. An induction hob comprising at least one heating induction coil and a switching converter, wherein the switching converter comprises:
a DC-bus having a high-side line and a low-side line for making available a DC voltage on the DC-bus between the high-side line and the low-side line;
a plurality of half-bridge switching stages connected electrically in parallel between the high-side line and the low-side line, each half-bridge switching stage of the plurality of half-bridge switching stages comprising a respective high-side controlled switch and a low-side controlled switch connected in series between them and sharing an intermediate current terminal of the half-bridge switching stage; and
at least one C-L-C resonant tank connected between two intermediate current terminals of two half-bridge switching stages of the plurality of half-bridge switching stages, wherein the C-L-C resonant tank comprises the induction heating coil and a pair of capacitors, wherein each capacitor of the pair of capacitors is connected in series to the induction heating coil and to the intermediate current terminal of a respective half-bridge switching stage of the plurality of half-bridge switching stages, wherein the C-L-C resonant tank is configured to be magnetically coupled with a respective load, thereby defining at least a first C-L-C resonant tank;
wherein the intermediate current terminal of each half-bridge switching stage of the plurality of half-bridge switching stages is directly connected to a respective capacitor of the pair of capacitors;
wherein each half-bridge switching stage of the plurality of half-bridge switching stages and the respective capacitor directly connected thereto are installed on a same circuit board; and
wherein the at least one C-L-C resonant tank is composed by the heat induction coil electrically connected in series between the pair of capacitors installed on the circuit board.

7. The induction hob of claim 6, wherein the pair of capacitors of a same resonant tank have substantially matched capacitance values.

8. The induction hob of claim 6, wherein the plurality of half-bridge switching stages comprises one half-bridge switching stage configured to act as a master half-bridge switching stage and another half-bridge switching stages configured to act as a slave half-bridge switching stage, wherein the C-L-C resonant tank is connected at one end to the current terminal of the master half-bridge switching stage and at the other end to the current terminal of the slave half-bridge switching stage and the resonant tank comprises a first induction heating coil.

9. The induction hob of claim 8, wherein said plurality of half-bridge switching stages further comprises at least yet another half-bridge switching stage configured to act as a second slave half-bridge stage, wherein the induction hob comprises at least a second C-L-C resonant tank, the at least second C-L-C resonant tank being connected between the intermediate current terminal of the master half-bridge switching stage and the intermediate current terminal of the second slave half-bridge switching stage and comprising a respective second induction heating coil.

10. The induction hob of claim 9, comprising a first plurality of “M” half-bridge switching stages, each of which is configured to act as a master half-bridge stage, and a second plurality of “N” half-bridge switching stages each of which is configured to act as a slave half-bridge stage, wherein the induction hob comprises “M×N” C-L-C resonant tanks, each C-L-C resonant tank of the M×N C-L-C resonant tanks being powered by a respective pair of half-bridge switching stages composed of a master half-bridge switching stage of the first plurality and of a slave half-bridge switching stage of the second plurality, the M×N C-L-C resonant tanks being connected between the intermediate current terminal of the master half-bridge switching stage of the respective pair and the intermediate current terminal of the slave half-bridge switching stage of the respective pair, wherein each M×N C-L-C resonant tank comprises a respective induction heating coil.

11. An induction hob comprising at least one heating induction coil and a switching converter, wherein the switching converter comprises:
a DC-bus having a high-side line and a low-side line for making available a DC voltage on the DC-bus between the high-side line and the low-side line;
a plurality of half-bridge switching stages connected electrically in parallel between the high-side line and the low-side line, each half-bridge switching stage of the plurality of half-bridge switching stages comprising a respective high-side controlled switch and a low-side controlled switch connected in series between them and sharing an intermediate current terminal of the half-bridge switching stage; and
at least one C-L-C resonant tank connected between two intermediate current terminals of two half-bridge switching stages of the plurality of half-bridge switching stages, wherein the C-L-C resonant tank comprises the induction heating coil and a pair of capacitors, wherein each capacitor of the pair of capacitors of at least one C-L-C resonant tank have substantially matched capacitance values and is directly connected in series to the induction heating coil and to one of the intermediate current terminal of a respective half-bridge switching stage of the plurality of half-bridge switching stages, wherein the C-L-C resonant tank is configured to be magnetically coupled with a respective load.

12. The induction hob of claim 11, wherein each half-bridge switching stage of the plurality of half-bridge switching stages and the respective capacitor directly connected thereto are installed on a same circuit board.

13. The induction hob of claim 12, wherein the circuit board is electrically shielded from the ground line and from any additional parts of the induction hob eventually connected thereto.

14. The induction hob of claim 12, wherein the at least one C-L-C resonant tank comprises the heat induction coil electrically connected in series between the pair of capacitors installed on the circuit board.

15. The induction hob of claim 11, wherein the current peaks at about 20 A.

16. The induction hob of claim 11, wherein the pair of capacitors are installed each one on a respective electronic board with the respective half-bridge stage, have matched values and the voltages to ground at their respective terminals of the induction heating coil are balanced.

17. The induction hob of claim 11, further comprising a matrix structure, wherein a single converter blocks (M and N) define half-bridge stages in electrical communication with a unique DC-bus from the electrical network.

18. The induction hob of claim 17, wherein the matrix system comprises a plurality of M half-bridge stages each of which is configured to act as a master half-bridge stage, and a plurality of N half-bridge switching stages each of which is configured to act as a slave half-bridge stage.

19. The induction hob of claim 18, wherein each one of the M master half-bridge stages is operably coupled to each one of the N slave half-bridge stages through a C-L-C resonant tank, and wherein M×N coils is obtained in which each coil of the M×N coils being connected between one master half-bridge stage and one slave half-bridge stage.

20. A method of reducing an electromagnetic disturbance injected though the ground line of an induction hob, the method comprising the steps of:
providing an induction hob comprising at least one heating induction coil and a switching converter;
connecting a DC-bus having a high-side line and a low-side line to the switching converter and making available a DC voltage on the DC-bus between the high-side line and the low-side line;
providing the switching converter with a plurality of half-bridge switching stages connected electrically in parallel between the high-side line and the low-side line, each half-bridge switching stage of the plurality of half-bridge switching stages comprising a respective high-side controlled switch and a low-side controlled switch connected in series between them and sharing an intermediate current terminal of the half-bridge switching stage; and
connecting at least one C-L-C resonant tank between two intermediate current terminals of two half-bridge switching stages of the plurality of half-bridge switching stages, wherein the C-L-C resonant tank comprises the induction heating coil and a pair of capacitors, wherein each capacitor of the pair of capacitors of at least one C-L-C resonant tank have substantially matched capacitance values and is directly connected in series to the induction heating coil and to one of the intermediate current terminal of a respective half-bridge switching stage of the plurality of half-bridge switching stages; and
configuring the C-L-C resonant tank to be magnetically coupled with a respective load.

21. The method of claim 20, further comprising the step of installing each half-bridge switching stage of the plurality of half-bridge switching stages and the respective capacitor on a same circuit board.

22. The method of claim 20, further comprising the step of installing the pair of capacitors each one on a respective electronic board with the respective half-bridge stage.

23. The method of claim 22, wherein the pair of capacitors have matched values and the voltages to ground at their respective terminals of the induction heating coil are balanced,

24. The method of claim 20, further comprising the step of electrically shielding the circuit board from the ground line and from any additional parts of the induction hob eventually connected thereto.

25. The method of claim 20, wherein the at least one C-L-C resonant tank comprises the heat induction coil electrically connected in series between the pair of capacitors installed on the circuit board.
